(19) United States
(12) Patent Application Publication
(10) Pub. No.: US 2026/0086823 A1
(43) Pub. Date: Mar. 26, 2026

(54) METHOD AND APPARATUS FOR CONSTRUCTING A PIPELINE BASED ON PROMPT UNIT COMBINATION

(71) Applicant: LANGCODE INC., Seoul (KR)

(72) Inventors: Min Jun KIM, Seoul (KR); Yun Jae KOH, Seoul (KR); Ji Soo HAN, Seoul (KR); Seung Woo CHO, Seoul (KR)

(21) Appl. No.: 19/398,617

(22) Filed: Nov. 24, 2025

Related U.S. Application Data
(63) Continuation of application No. PCT/KR2025/099453, filed on Feb. 19, 2025.

(30) Foreign Application Priority Data
Oct. 10, 2024 (KR) 10-2024-0137293
May 10, 2024 (KR) 10-2024-0061549

(51) Int. Cl. G06F 9/445

(52) U.S. Cl. CPC G06F 9/44505

(57) ABSTRACT

An embodiment relates to a method for providing responses through a prompt pipeline structure, and more particularly, a pipeline construction method based on combinations of prompt units. The method comprises: configuring one or more prompt layers selected from among candidate artificial intelligence models based on at least one of availability, cost, and performance of each artificial intelligence model; configuring, for each layer, a set of prompt modules according to the selected artificial intelligence model; and constructing a pipeline by selecting, from among preset candidate prompt units for each of the prompt modules included in the prompt module set, one or more prompt units satisfying specific conditions, and configuring, based on the selected prompt units, combinations of prompt units for the respective prompt modules included in the prompt module set.

### CROSS-REFERENCE TO RELATED APPLICATION

This application is a continuation of International Application No. PCT/KR2025/099453 filed on February 19, 2025, which claims priority to Korean Patent Application No. 10-2024-0061549, filed on May 10, 2024, and to Korean Patent Application No. 10-2024-0137293, filed on October 10, 2024, the entire contents of which are herein incorporated by reference.

### BACKGROUND

### FIELD

The present invention relates to a method and apparatus for constructing a pipeline based on a combination of prompt units, and more particularly, to a method and apparatus for constructing a pipeline by configuring one or more prompt layers, configuring a combination of prompt modules corresponding to each prompt layer, and configuring a combination of prompt units for each prompt module.

In modern enterprise environments, the importance of generative AI is rapidly increasing. Due to the explosive growth of data and the diversification of business requirements, enterprises require technological means capable of rapidly processing large volumes of information and providing customer-tailored solutions based thereon. To meet such demands, generative AI has become a powerful tool in various areas such as natural language processing (NLP), knowledge extraction, and user question-and-answer systems.

The advancement of large language models (LLMs) has opened up new possibilities that go beyond the limitations of conventional generative AI technology. Although an LLM is capable of generating human-like natural language by learning from large-scale datasets, additional information retrieval and data processing technologies are required for it to accurately respond to complex user requirements beyond simple text generation. In this context, the importance of the Retrieval-Augmented Generation (RAG) architecture has been highlighted.

RAG uses a method of enhancing text generation based on information acquired through retrieval. In this process, the LLM retrieves relevant data prior to generating an answer to a given query and utilizes the data to produce a more accurate and detailed response. This function is essential particularly in enterprise AI platforms where rapid information retrieval and processing are crucial.

However, conventional RAG architectures depend on fixed retrieval criteria and generation methods, thereby having limitations in flexibly responding to diverse work environments and changing enterprise requirements. In particular, to provide optimal results desired by a client company, a generative AI system needs the capability to effectively utilize various LLMs and automatically select the optimal processing method among numerous possible data handling approaches.

Against this background, a new architecture referred to as a “prompt pipeline” has been proposed. This architecture aims to solve major issues faced by RAG-based generative AI systems and to maximize the potential of LLMs, thereby more effectively satisfying the requirements of enterprise AI platforms.

To meet the demand levels of various enterprise clients, highly advanced chatbots are required to implement numerous functions through Advanced RAG technology. Although the RAG process, which combines information retrieval and generation, is essential for producing more accurate and detailed responses, the integration and optimization become more difficult as the level of questions and answers increases and as additional functions are incorporated.

In particular, a core technology is required to organically combine complex stages such as data processing, natural language understanding, and response generation without conflicts, to implement functions seamlessly, and to automate these processes.

### SUMMARY

The present invention has been made to solve the problems of the related art described above, and provides a method and apparatus for constructing a pipeline by configuring one or more prompt layers, configuring a combination of prompt modules corresponding to each prompt layer, and configuring a combination of prompt units for each prompt module.

The technical problems to be achieved by the present invention are not limited to those described above, and other technical problems may be derived from the following description of the invention.

As a technical means for solving the above-described technical problems, an embodiment according to a first aspect of the present disclosure provides a method for constructing a pipeline based on a combination of prompt units. The method includes: configuring one or more prompt layers selected based on at least one of the availability, cost, and performance of each artificial intelligence model among a plurality of candidate artificial intelligence models; configuring, for each layer, a set of prompt modules according to the selected artificial intelligence model; and constructing a pipeline by, for each prompt module included in the set of prompt modules, selecting a prompt unit that satisfies a specific condition among preset candidate prompt units, and configuring a combination of prompt units for each prompt module based on the selected prompt units.

As a technical means for solving the above-described technical problems, an embodiment according to a second aspect of the present disclosure provides an apparatus for constructing a pipeline based on a combination of prompt units. The apparatus includes a communication module, at least one processor, and a memory electrically connected to the processor and storing at least one code executed by the processor. The memory stores a code that, when executed through the processor, causes the processor to configure one or more prompt layers selected based on at least one of the availability, cost, and performance of each artificial intelligence model among a plurality of candidate artificial intelligence models, to configure, for each layer, a set of prompt modules according to the selected artificial intelligence model, to select, for each prompt module included in the set of prompt modules, a prompt unit satisfying a specific condition among preset candidate prompt units, and to construct a pipeline by configuring a combination of prompt units for each prompt module based on the selected prompt units.

According to the present invention, user satisfaction can be significantly improved through the accuracy and detail of responses provided by AI.

In addition, according to the present invention, user experience can be enhanced by providing more human-like and accurate responses to each user's query through advanced customized configurations.

According to the present invention, customized solutions capable of satisfying complex and diverse requirements arising in various work environments can be provided to meet enterprise needs.

According to the present invention, the disclosed technology can be efficiently applied to various fields such as business intelligence, customer service, and research and development.

According to the present invention, a powerful framework for RAG processes is provided, and data integration, retrieval, natural language processing, and response generation are organically processed to enable dynamic RAG implementation and integrated data processing.

According to the present invention, complex information processing demands can be efficiently satisfied, enabling AI to generate more accurate and useful information.

According to the present invention, a flexible structure that can be easily expanded or modified according to enterprise growth and changing requirements can be provided.

According to the present invention, the value as a long-term technological solution can be increased, and it can be applied to various industries and use cases.

According to the present invention, the quality and speed of AI responses can be improved, and performance and data processing accuracy can be enhanced by maximizing the capability to rapidly and accurately extract and process relevant information from large-scale data sources.

According to the present invention, enterprise operational efficiency can be increased, and quick responses can be provided to users.

According to the present invention, through complex natural language understanding and generation processes, more human-like conversations and responses can be provided, thereby enabling advanced natural language processing and user-customized solutions.

According to the present invention, flexibility can be secured to provide customized responses and solutions that suit various user requirements and situations.

According to the present invention, the prompt pipeline architecture establishes a new standard for generative AI technology and provides substantial value to all users and enterprises utilizing enterprise AI platforms.

According to the present invention, the efficiency, accuracy, and flexibility of enterprise AI platforms can be maximized, enabling enterprises to make data-driven decisions more quickly and accurately.

The effects of the present invention are not limited to the above-described effects, and include all effects understood from the following description of the invention.

### BRIEF DESCRIPTION OF THE DRAWINGS

FIG. 1 is a diagram illustrating an automated pipeline construction apparatus and a terminal communicatively connected thereto according to an embodiment of the present invention.

FIG. 2 is a diagram illustrating a detailed configuration of a server shown in FIG. 1.

FIG. 3 is a diagram illustrating an example for explaining a process of providing an optimal answer using the pipeline construction apparatus.

FIG. 4 is a diagram illustrating an embodiment for explaining a process of providing an optimal answer using the pipeline construction apparatus.

FIG. 5 is a flowchart illustrating a sequence of a response providing method of an automated prompt pipeline structure according to another embodiment of the present invention.

### DETAILED DESCRIPTION

Hereinafter, embodiments of the present disclosure will be described in detail with reference to the accompanying drawings. However, the present disclosure may be implemented in various different forms, and is not limited to the embodiments described herein. The drawings are provided merely to facilitate understanding of the embodiments disclosed in this specification, and the technical idea disclosed herein is not limited by the accompanying drawings. All terms, including technical and scientific terms used herein, are to be interpreted as having meanings commonly understood by those of ordinary skill in the art to which the present disclosure pertains. Predetermined terms should be interpreted as additionally including meanings consistent with the related technical literature and the contents disclosed herein, and unless otherwise defined, the terms should not be interpreted as having excessively idealized or restrictive meanings.

In the drawings, parts not related to the explanation of the present disclosure are omitted for clarity, and the sizes, shapes, and forms of elements illustrated in the drawings may be variously modified. Throughout the specification, the same or similar reference numerals are used to designate the same or similar elements.

In describing the embodiments disclosed in this specification, detailed descriptions of well-known related technologies may be omitted when it is determined that such descriptions may obscure the gist of the disclosed embodiments.

Throughout the specification, when a part “includes,” “comprises,” or “is provided with” a certain component, this means that, unless otherwise stated, it does not exclude the possibility of including or being provided with other components in addition to the mentioned component.

In this specification, ordinal terms such as “first” and “second” are used merely for the purpose of distinguishing one element from another and do not limit the order or relationship between the elements. For example, a first component of the present disclosure may be referred to as a second component, and similarly, the second component may be referred to as the first component. Singular expressions used in this specification are to be interpreted as also including plural forms unless clearly indicated otherwise.

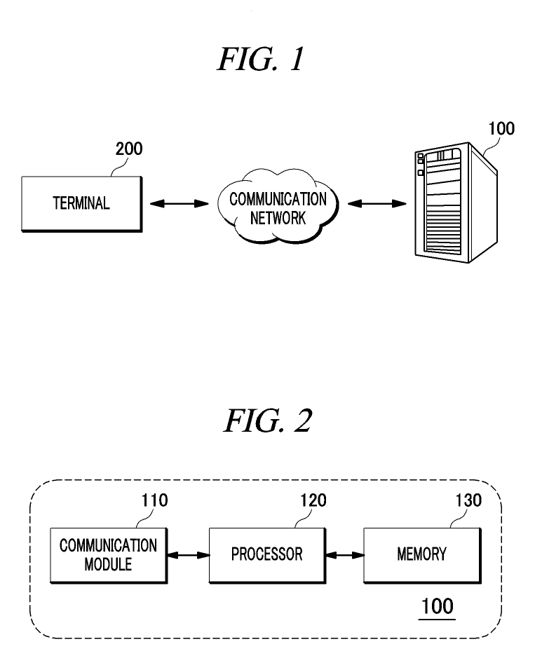

FIG. 1 is a diagram illustrating an automated pipeline construction apparatus and a terminal communicatively connected thereto according to an embodiment of the present invention.

Referring to FIG. 1, an automated pipeline construction apparatus (100) may be communicatively connected to a terminal (200) through a predetermined communication network.

The pipeline construction apparatus (100) configures one or more prompt layers selected based on at least one of the availability, cost, and performance of each artificial intelligence model among a plurality of candidate artificial intelligence models.

The pipeline construction apparatus (100) configures, for each layer, a set of prompt modules according to the selected artificial intelligence model.

The pipeline construction apparatus (100) selects, for each prompt module included in the set of prompt modules, a prompt unit that satisfies a specific condition among preset candidate prompt units, and constructs a pipeline by configuring a combination of prompt units for each prompt module based on the selected prompt units.

The pipeline construction apparatus (100) is capable of overcoming the limitations of conventional technologies through an automated and optimized pipeline architecture based on artificial intelligence models.

The pipeline construction apparatus (100) can prevent conflicts between components and derive optimized performance. For example, through a complex pipeline including various prompt units, prompt modules, and prompt layers, the pipeline construction apparatus (100) enables each component to operate organically without conflict, while maximizing the efficiency and accuracy of the overall system. Through this configuration, the pipeline construction apparatus (100) allows the artificial intelligence model to automatically select and configure an optimal combination according to the situation, thereby automatically providing optimal results that meet the requirements of client companies.

The pipeline construction apparatus (100) may be implemented in the form of a server, computing device, or various smart devices, and may operate within cloud computing service models such as Software as a Service (SaaS), Platform as a Service (PaaS), or Infrastructure as a Service (IaaS). In addition, the pipeline construction apparatus (100) may be built as a private cloud, public cloud, or hybrid cloud system; however, the scope of the present invention is not limited thereto.

The pipeline construction apparatus (100) can provide flexibility and functional scalability for each industry.

For example, the pipeline construction apparatus (100) can provide a structure that actively responds to changing requirements in enterprise environments. The pipeline construction apparatus (100) enables the design of customized AI solutions that meet various data processing and analytical requirements encountered by enterprises or users.

The pipeline construction apparatus (100) can be easily implemented without human labor by automatically selecting and utilizing AI-required elements within an already constructed pipeline.

The pipeline construction apparatus (100) can integrate advanced natural language processing (NLP) functions. For example, the pipeline construction apparatus (100) can incorporate advanced NLP functions capable of deeply understanding user queries and generating more accurate and natural responses. Such advanced natural language processing functionality is essential for generating personalized answers to complex user questions or requirements.

The pipeline construction apparatus (100) can enhance the efficiency of data integration and retrieval. The pipeline construction apparatus (100) can improve its ability to rapidly and accurately retrieve necessary information from large-scale datasets. Through the pipeline, the pipeline construction apparatus (100) increases the speed of information retrieval and processing, thereby providing users with faster responses.

The pipeline construction apparatus (100) can improve the accuracy of customized answer generation. The pipeline construction apparatus (100) can enhance the capability of AI to generate more accurate and personalized answers to user questions or requests. Accordingly, the pipeline construction apparatus (100) can enrich each user’s experience and contribute to increasing customer satisfaction.

The pipeline construction apparatus (100) can strengthen the versatility and scalability of the model. The pipeline construction apparatus (100) can be applied to various industries and use cases, and can develop flexible AI solutions that easily adapt and expand over time. Through this, the pipeline construction apparatus (100) can effectively respond to future technological changes or fluctuations in business requirements.

The pipeline construction apparatus (100) can implement an advanced RAG (Retrieval-Augmented Generation) system that solves various problems arising in enterprise environments.

The pipeline construction apparatus (100) can address challenges such as data processing, information retrieval, integration of advanced NLP functions, improvement of accuracy in customized answer generation for user queries, and enhancement of model versatility and scalability.

By providing a highly advanced generative artificial intelligence model-based system capable of flexibly responding to diverse enterprise requirements, the pipeline construction apparatus (100) can maximize the performance and efficiency of enterprise AI platforms and contribute to increasing end-user satisfaction.

A terminal (200) may transmit a query to the pipeline construction apparatus (100) and receive an optimal answer to the query from the pipeline construction apparatus (100).

The terminal (200) may refer to any type of handheld wireless communication device such as a laptop, desktop, or notebook equipped with a web browser, as well as portable and mobile wireless communication devices such as smartphones or tablet PCs.

FIG. 2 is a diagram illustrating a detailed configuration of the server shown in FIG. 1.

Referring to FIG. 2, the pipeline construction apparatus (100) may include a communication module (110), a processor (120), and a memory (130).

The communication module (110) may include a device comprising hardware and software necessary for transmitting and receiving signals, such as control signals or data signals, through wired or wireless connections with other network devices.

The communication module (110) may receive a query from the terminal and provide an optimal answer to the query to the terminal.

The processor (120) may include various types of devices for controlling and processing data. The processor (120) may refer to a hardware-embedded data processing device having physically structured circuits to perform functions represented by codes or commands included in a program.

In one example, the processor (120) may be implemented in the form of a microprocessor, a central processing unit (CPU), a processor core, a multiprocessor, an application-specific integrated circuit (ASIC), or a field programmable gate array (FPGA). However, the scope of the present invention is not limited thereto.

The processor (120) performs operations according to codes stored in the memory (130).

The memory (130) may store at least one or more of the following: information and data input through the communication module (110), information and data required for the functions performed by the processor (120), and data generated according to the execution of the processor (120).

The memory (130) should be interpreted as a general term including non-volatile storage devices that maintain stored information even when power is not supplied, and volatile storage devices that require power to maintain stored information. The memory (130) may include, in addition to volatile storage devices that require power to retain stored information, cloud storage, solid state drives (SSD), magnetic storage media, or flash storage media. However, the scope of the present invention is not limited thereto.

The memory (130) is electrically connected to the processor (120) and stores at least one code executed by the processor (120). The memory (130) stores a code that, when executed through the processor (120), causes the processor (120) to perform the following functions and procedures.

The memory (130) stores a code that causes the processor (120) to configure one or more prompt layers including artificial intelligence models by considering at least one of availability, budget, and quality. Here, a plurality of prompt layers may be connected in at least one form of sequential or parallel structure to construct a pipeline, and each of the plurality of prompt layers may include a plurality of prompt modules combined in different ways. The prompt layer may perform a main function for providing an answer to a query input to the pipeline. In addition, the artificial intelligence model may be a frozen open-source model.

The memory (130) may store a code that causes the processor (120) to filter a plurality of artificial intelligence models based on at least one of operation status, availability, and processing capacity of the artificial intelligence models.

The memory (130) may store a code that causes the processor (120) to extract one or more artificial intelligence models from among the filtered artificial intelligence models based on at least one of cost, answer generation time for a query, processing speed, and score, and to configure one or more prompt layers.

The memory (130) may store a code that causes the processor (120) to rank a plurality of artificial intelligence models and to configure a prompt layer corresponding to a second-ranked artificial intelligence model when the first-ranked artificial intelligence model changes.

If an input query is related to data extraction, the pipeline structure may be constructed by connecting the plurality of prompt layers in order of their degree of relevance to data extraction based on the code stored in the memory (130).

The memory (130) may store a code that causes the processor (120) to integrate a plurality of prompt modules into a single prompt layer and to provide multilayered functions for complex processing and advanced tasks through the prompt layer. Here, each prompt layer may be designed for a specific purpose and may operate organically, with emphasis on conflict prevention and efficiency enhancement for overall system optimization.

The memory (130) may store a code that causes the processor (120) to analyze the purpose of a query and to configure a prompt layer corresponding to the identified purpose. Each prompt layer may include a plurality of prompt modules combined in different ways.

The memory (130) may store a code that causes the processor (120) to optimize various prompt layers configured within the pipeline by domain or enterprise, and to handle detailed functions by changing the prompt units and prompt modules.

The memory (130) stores a code that causes the processor (120) to configure, for each layer, a set of prompt modules according to the selected artificial intelligence model. For example, the memory (130) may store a code that causes the processor (120) to generate a set of prompt modules by combining prompt modules corresponding to at least one of the type of the query and the characteristics of the user among a plurality of prompt modules included in the prompt layer, and to configure them for each layer. Here, each prompt module may perform a specific sub-function required to accomplish the main function.

For example, if an input query is related to data extraction, the processor (120) may, based on the code stored in the memory (130), arrange the prompt modules of a plurality of prompt modules included in a first prompt layer having the highest degree of relevance to data extraction among the plurality of prompt layers according to the relevance to data extraction and user characteristics, and configure the set of prompt modules for each layer.

The memory (130) may store a code that causes the processor (120) to perform larger functions or task groups through prompt modules generated by combining multiple prompt units. The prompt modules may be designed specifically to meet complex enterprise requirements and may automatically select an optimal combination of prompt units according to user needs to implement corresponding functions. Accordingly, the flexibility and scalability of the AI system can be greatly enhanced.

The memory (130) stores a code that causes the processor (120) to select, for each prompt module included in the set of prompt modules, a prompt unit satisfying a specific condition among preset candidate prompt units, and to construct a pipeline by configuring a combination of prompt units for each prompt module based on the selected prompt units.

Here, each prompt unit is designed to implement a command for executing a specific sub-function and may serve as a fundamental operational unit of the artificial intelligence model. The prompt units may be used independently or in combination according to various requirements and may perform specific tasks such as requesting information on a particular subject or transforming sentence formats.

The memory (130) may store a code that causes the processor (120) to extract a prompt unit from among preset candidate prompt units based on at least one of an error state, user feedback score, internal confidence level, and query. Accordingly, even when the same artificial intelligence model is configured for different queries, the combination of prompt units may vary. Here, the preset candidate prompt units may be received from a database communicatively connected to the communication module (110).

The memory (130) may store a code that causes the processor (120) to perform at least one of information requests, response provision, and sentence format conversion for a query through the prompt units.

For example, when the input query is related to data extraction, the processor (120) may, based on the code stored in the memory (130), independently or combinationally utilize prompt units corresponding to the requirements among a plurality of prompt units included in the configured first prompt module to provide an optimal answer.

The memory (130) may store a code that causes the processor (120) to prevent conflicts among the plurality of prompt layers, the plurality of prompt modules, and the plurality of prompt units through orchestration.

Here, “orchestration” refers to a process of ensuring that the pipeline executes according to its intended purpose without conflicts occurring among each configuration unit (layer, module, or unit). For example, the memory (130) may store a code that, when the configuration of a prompt unit combination fails, replaces the existing prompt unit with another prompt unit having the same purpose; when the configuration of a prompt module fails, replaces the existing prompt module with another prompt module having the same purpose; and when the configuration of a prompt layer fails, changes the configuration of the corresponding prompt module.

The memory (130) may store a code that causes the pipeline structure generation apparatus to reattempt an operation through orchestration when internal confidence, input requirements, or satisfaction conditions of a subsequent prompt layer are not met. In addition, the memory (130) may store a code that causes the processor (120) to recommend a new prompt module–prompt unit combination within a new prompt layer or within the same prompt layer, and to retry when the format required by a subsequent prompt layer is not satisfied.

For example, when the prompt layers include a first prompt layer and a second prompt layer that are sequentially interconnected, the memory (130) may store a code that causes the processor (120) to use the output of the first prompt layer as the input of the second prompt layer. If the output of the first prompt layer does not satisfy a preset input requirement of the second prompt layer, the code may cause the processor (120) to change the configuration of the prompt modules and prompt units of at least one of the first or second prompt layers.

The memory (130) may store a code that causes the processor (120) to optimize a pipeline constructed to include one or more prompt layers.

For example, the memory (130) may store a code that causes the processor (120) to monitor in real time at least one of the overall performance of the pipeline and the performance of each of the one or more prompt layers.

In another example, the memory (130) may store a code that causes the processor (120) to change the configuration of the pipeline when a performance indicator of the pipeline is equal to or less than a preset performance threshold.

In another example, the memory (130) may store a code that causes the processor (120) to explore an optimal configuration of the pipeline based on at least one of a genetic algorithm and a reinforcement learning technique in order to derive an answer to a query using the pipeline, and to match, store, and train the query, the answer, and the optimal configuration of the pipeline.

In another example, the memory (130) may store a code that causes the processor (120) to execute, in parallel, the configuration of an existing pipeline and a configuration of a new pipeline different from the existing pipeline, to compare the performance of the existing pipeline and the new pipeline, and to select and apply the pipeline having higher performance according to the comparison result.

In another example, the memory (130) may store a code that causes the processor (120) to gradually apply minor modifications in the order of prompt units, prompt modules, and prompt layers to maintain system stability, and to perform monitoring for a predetermined period after the modification to evaluate long-term effects.

In another example, the memory (130) may store a code that causes the processor (120) to store information on successful configurations and failed configurations of the pipeline and to reflect such information in subsequent reconfiguration processes.

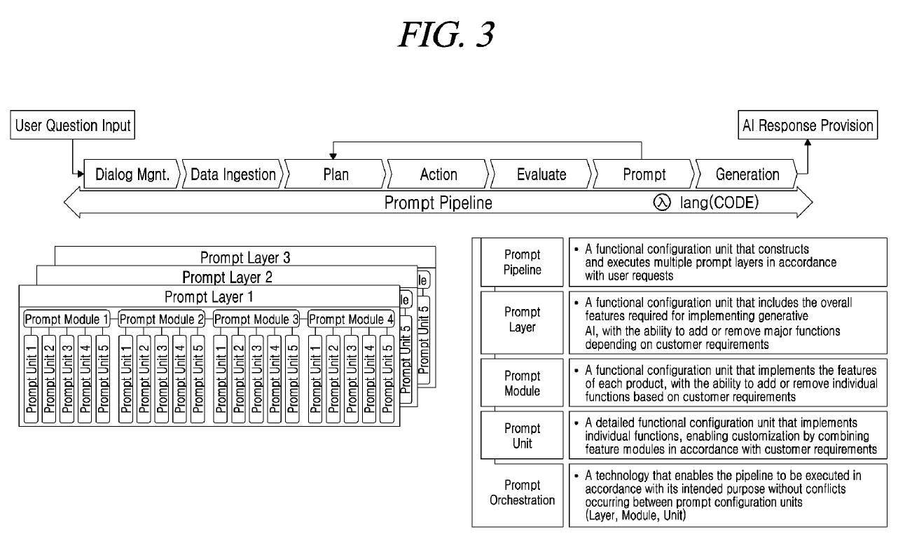

FIG. 3 is a diagram illustrating an example for explaining a process of providing an optimal answer using the pipeline construction apparatus.

Referring to FIG. 3, the pipeline construction apparatus may configure a prompt module by combining a plurality of prompt units and may configure a prompt layer by combining a plurality of prompt modules. Here, the pipeline construction apparatus may provide an answer to a user request through a pipeline including a plurality of prompt layers.

The prompt pipeline may be a functional configuration unit that constructs and implements multiple prompt layers in a sequential flow according to a user request.

A prompt layer refers to an overall functional configuration unit required to construct a generative AI, and primary functions may be added or excluded depending on customer requirements.

A prompt module refers to a functional configuration unit that implements individual functions of each product, and individual functions may be added or excluded depending on customer requirements.

A prompt unit refers to a detailed functional configuration unit that implements each sub-function, and functions may be customized by combining codes according to customer requirements.

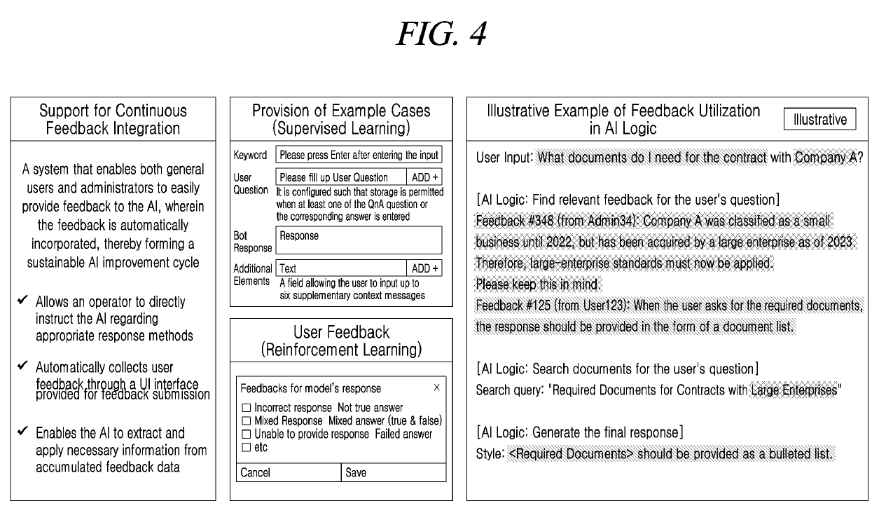

FIG. 4 is a diagram illustrating an embodiment for explaining a process of providing an optimal answer using the pipeline construction apparatus.

Referring to FIG. 4, the pipeline construction apparatus may reflect continuous feedback. For example, the pipeline construction apparatus allows both general users and administrators to easily provide feedback to the AI, and automatically incorporates such feedback to implement a sustainable AI improvement cycle.

For instance, the pipeline construction apparatus enables a business operator to directly instruct the AI on an appropriate answering method, provides a user interface (UI) for collecting user opinions, and automatically searches for and incorporates necessary contents among collected opinions and feedback through the AI.

The pipeline construction apparatus may automatically perform management operations such as generation, assignment, and training of AI bots corresponding to individual users.

The pipeline construction apparatus may determine an optimal artificial intelligence model (LLM), prompt module, and prompt unit by considering the difficulty, context, and feedback of a task or request through its own AI engine.

The pipeline construction apparatus may determine which combination of prompt modules among a plurality of prompt modules is to constitute one prompt layer, and may use an optimal combination of prompt modules most suitable for a user request such as a query.

The pipeline construction apparatus may determine which combination of prompt units among a plurality of prompt units is to constitute one prompt module, and may use an optimal combination of prompt units most suitable for a user request such as a query.

As described above, the pipeline construction apparatus may generate countless combinations at each stage, and each combination of prompt units and AI-related codes may be designed to operate without conflicts. Here, the combinations may be formed based on at least one of preset conditions, recommendations, reinforcement learning dimensions (such as user “like” or “dislike” scores), and user historical data.

The pipeline construction apparatus may select one artificial intelligence model from among a plurality of artificial intelligence models based on at least one of availability, cost, performance, and test values. For example, among available large language models (LLMs), the apparatus may first evaluate the availability (such as operation status, usability, and processing capacity), and then consider cost and performance. Here, the cost refers to the impact on the user’s set or expected cost, and the performance refers to past performance results, which may be evaluated based on generation time, processing speed, and scores.

The pipeline construction apparatus may select a second-ranked artificial intelligence model when the first-ranked artificial intelligence model changes.

The pipeline construction apparatus (100) may combine prompt units corresponding to each prompt module. Candidate prompt units for each prompt module may be stored in a database that is either communicatively connected to the pipeline construction apparatus or embedded within the pipeline structure generation apparatus.

When a user query is received, the pipeline construction apparatus (100) may call an artificial intelligence model (LLM). At this time, the pipeline construction apparatus (100) may perform a first LLM call for generating a search query based on a client request, and a second LLM call for combining the query and feedback.

The pipeline construction apparatus (100) may perform retrieval through the first LLM call and select a search result suitable for the query based on the retrieval result and the second LLM call.

The pipeline construction apparatus (100) may configure a combination of prompt units based on the search result.

The pipeline construction apparatus (100) may perform a third LLM call for generating a final answer based on the configured combination of prompt units and generate the final answer.

The pipeline construction apparatus (100) may collect and record feedback on the final answer to improve the AI inference engine.

As described above, the performance and accuracy of RAG or similar architectures may vary depending on the client’s data, query, tasks, and usage patterns. Accordingly, for providing client-specific AI services, optimization tailored to each task is required. However, performing manual optimization by developers or engineers is impractical. The pipeline construction apparatus (100), however, can perform automatic optimization and continuous improvement, and can utilize new models and small language models (SLMs) without dependency on a specific LLM.

As described above, the pipeline construction apparatus (100) can provide an optimal answer to a query.

For example, the pipeline construction apparatus (100) may be applied to ETL (Extract, Transform, Load) and data analysis automation in shipyards.

When an input query is “Can we accommodate the engine room layout change in the Qatar Gas LNG project?”, examples of prompt layers, prompt modules, and prompt units may be as follows.

Prompt layer 1 may be a prompt layer performing a main function related to document structure analysis and data extraction, and may include a prompt module A that performs a detailed function of document structure recognition and a prompt module B that performs a detailed function of data extraction.

Prompt module A may include a plurality of prompt units. For example, prompt module A may include: a prompt unit A1 that generates a command sentence of “Identify the start and end positions of a table in the input document.”; a prompt unit A2 that generates a command sentence of “Determine whether the header row of the table consists of a single row or multiple rows.”; and a prompt unit A3 that generates a command sentence of “Specify the actual header range of the table and infer the meaning of each column.”

Prompt module B may include a plurality of prompt units. For example, prompt module B may include: a prompt unit B1 that generates a command sentence of “Extract questions and answers separately from each row.”; a prompt unit B2 that generates a command sentence of “Identify the chronological order of the extracted question–answer pairs.”; and a prompt unit B3 that generates a command sentence of “Group consecutive question–answer pairs into a single thread.”

Prompt layer 1 may be composed of a plurality of prompt unit pools. For example, prompt layer 1 may include at least one prompt unit pool selected from among a table position identifier, header structure analyzer, column meaning inferencer, question–answer separator, chronological order detector, and thread grouper.

Prompt layer 2 may be a prompt layer performing a main function related to data refinement and structuring, and may include a prompt module A that performs a detailed function of data normalization and a prompt module B that performs a detailed function of metadata generation.

Prompt module A may include a plurality of prompt units. For example, prompt module A may include: a prompt unit A1 that generates a command sentence of “Convert the extracted question–answer pairs into a standard format. Format: {Question: '', Answer: '', Date: '', ThreadID: ''}”; a prompt unit A2 that generates a command sentence of “Add at least three related keywords as tags for each question–answer pair.”; and a prompt unit A3 that generates a command sentence of “Summarize the final conclusion or agreement of each thread in one sentence.”

Prompt module B may include a plurality of prompt units. For example, prompt module B may include: a prompt unit B1 that generates a command sentence of “Indicate whether each thread caused additional cost as ‘True’ or ‘False.’”; a prompt unit B2 that generates a command sentence of “Indicate whether each thread caused additional risk as ‘True’ or ‘False.’”; and a prompt unit B3 that generates a command sentence of “Indicate whether a final agreement was reached in each thread as ‘True’ or ‘False.’”

Prompt layer 2 may be composed of a plurality of prompt unit pools. For example, prompt layer 2 may include at least one prompt unit pool selected from among a standard format converter, keyword tag generator, thread summarizer, cost occurrence determiner, risk occurrence determiner, and agreement status determiner.

Prompt layer 3 may be a prompt layer performing a main function related to information retrieval and relevance analysis, and may include a prompt module A that performs a detailed function of keyword extraction and a prompt module B that performs a detailed function of related data retrieval.

Prompt module A may include a plurality of prompt units. For example, prompt module A may include: a prompt unit A1 that generates a command sentence of “Extract three key keywords from the input query.”; and a prompt unit A2 that generates a command sentence of “Present two synonyms or related terms for each extracted keyword.”

Prompt module B may include a plurality of prompt units. For example, prompt module B may include: a prompt unit B1 that generates a command sentence of “Search the database for related threads using the extracted keywords and related terms.”; a prompt unit B2 that generates a command sentence of “Evaluate the relevance between the retrieved threads and the input query on a scale of 1 to 10, and select the top five.”; and a prompt unit B3 that generates a command sentence of “Summarize the key content of each of the five selected threads in one sentence.”

Prompt layer 3 may be composed of a plurality of prompt unit pools. For example, prompt layer 3 may include at least one prompt unit pool selected from among a core keyword extractor, synonym generator, database retriever, relevance evaluator, and thread summarizer.

Prompt layer 4 may be a prompt layer performing a main function related to analysis and proposal generation, and may include a prompt module A that performs a detailed function of pattern analysis and a prompt module B that performs a detailed function of proposal generation.

Prompt module A may include a plurality of prompt units. For example, prompt module A may include: a prompt unit A1 that generates a command sentence of “Calculate the frequency of additional cost occurrences from the selected threads.”; a prompt unit A2 that generates a command sentence of “Calculate the frequency of risk occurrences from the selected threads.”; and a prompt unit A3 that generates a command sentence of “Describe the correlation between additional cost occurrences and risk occurrences in one sentence.”

Prompt module B may include a plurality of prompt units. For example, prompt module B may include: a prompt unit B1 that generates a command sentence of “Based on the analysis results, present three possible response plans for the engine room layout change request.”; a prompt unit B2 that generates a command sentence of “Describe the advantages and disadvantages of each response plan in one sentence.”; and a prompt unit B3 that generates a command sentence of “Select the most recommended response plan and explain the reason in two sentences.”

Prompt layer 4 may be composed of a plurality of prompt unit pools. For example, prompt layer 4 may include at least one prompt unit pool selected from among a cost frequency calculator, risk frequency calculator, correlation analyzer, response plan generator, advantage–disadvantage analyzer, and optimal plan selector.

Prompt layer 5 may be a prompt layer performing a main function related to response generation and visualization, and may include a prompt module A that performs a detailed function of response composition and a prompt module B that performs a detailed function of data visualization.

Prompt module A may include a plurality of prompt units. For example, prompt module A may include: a prompt unit A1 that generates a command sentence of “Write a three-paragraph response to the user’s query based on the analysis results and proposed plans.”; a prompt unit A2 that generates a command sentence of “Begin the first sentence of the response with a summary reflecting the essence of the query.”; and a prompt unit A3 that generates a command sentence of “Add one sentence at the end of the response indicating additional considerations or cautions.”

Prompt module B may include a plurality of prompt units. For example, prompt module B may include: a prompt unit B1 that generates a command sentence of “Organize the key contents of the related threads in a table format. Columns: {Date, Question Summary, Answer Summary, Cost Incurred, Risk}”; a prompt unit B2 that generates a command sentence of “Represent the frequencies of additional cost and risk occurrences in a pie chart.”; and a prompt unit B3 that generates a command sentence of “List the proposed response plans as bullet points and highlight the recommended plan.”

Prompt layer 5 may be composed of a plurality of prompt unit pools. For example, prompt layer 5 may include at least one prompt unit pool selected from among a response composer, summary generator, caution adder, table formatter, graph generator, and bullet point lister.

As described above, the pipeline construction apparatus may flexibly respond to various document formats and query types through the configured prompt unit pool and initial pipeline and may replace prompt units or construct a new combination of pipelines as needed.

The structures of initial pipelines 1 and 2 may be as follows.

Initial pipeline 1 may be a precision analysis structure and may include prompt layers 1 through 5.

Prompt layer 1 may include prompt module A, and prompt module A may include prompt units A1 through A3.

Prompt layer 2 may include prompt module B, and prompt module B may include prompt units B1 through B3.

Prompt layer 3 may include prompt module C, and prompt module C may include prompt units C1 through C3.

Prompt layer 4 may include prompt module D, and prompt module D may include prompt units D1 through D3.

Prompt layer 5 may include prompt module E, and prompt module E may include prompt units E1 through E3.

Initial pipeline 2 may be a large-scale data processing structure and may include prompt layers 1 through 5.

Prompt layer 1 may include prompt module F, and prompt module F may include prompt units F1 through F3.

Prompt layer 2 may include prompt module G, and prompt module G may include prompt units G1 through G3.

Prompt layer 3 may include prompt module H, and prompt module H may include prompt units H1 through H3.

Prompt layer 4 may include prompt module I, and prompt module I may include prompt units I1 through I3.

Prompt layer 5 may include prompt module J, and prompt module J may include prompt units J1 through J3.

When the pipeline construction apparatus fails to generate an optimal response to a query through the pipeline structure, it may perform a retry operation.

For example, when it is determined that the configuration of a prompt unit combination has failed according to a preset prompt unit selection criterion, the apparatus may replace a prompt unit in the prompt unit combination that does not meet the criterion with another prompt unit having the same purpose. For instance, when the prompt unit A1 in prompt layer 1 of pipeline 1 fails, it may be replaced with prompt unit A3. Here, the preset prompt unit selection criterion may include at least one of a reliability criterion failure, an error occurrence, a lack of information required for answer generation, and failure to provide an answer to the query.

In another example, when it is determined that the configuration of a prompt module set has failed according to a preset prompt module configuration criterion, the apparatus may replace a prompt module in the prompt module set that does not meet the criterion with another prompt module having the same purpose. For instance, when prompt module B in prompt layer 2 of pipeline 1 fails, it may be replaced with prompt module G from pipeline 2. Here, the preset prompt module configuration criterion may be the performance of the prompt module.

In another example, when it is determined that the configuration of a prompt layer has failed according to a preset prompt layer configuration criterion, the apparatus may modify the configuration of the prompt module set to reconstruct the prompt layer with a new combination of prompt modules. For instance, prompt layer 3 may be reconstructed by combining prompt module C and prompt module H. Here, the preset prompt layer configuration criterion may include at least one of availability, performance, cost, and lack of information.

In another example, the apparatus may construct a new pipeline by combining the strengths of multiple pipelines. For instance, a hybrid pipeline may include prompt layers 1 through 5. Prompt layer 1 may include prompt module F from pipeline 2, prompt layer 2 may include prompt module B from pipeline 1, prompt layer 3 may include prompt module C from pipeline 1 and prompt module H from pipeline 2, prompt layer 4 may include prompt module I from pipeline 2, and prompt layer 5 may include prompt module E from pipeline 1.

In another example, the pipeline construction apparatus may be applied to a generative AI service used by employees of an insurance company.

When the input query is “If a polyp is found during a colonoscopy, how should the review be conducted?”, examples of the prompt layer, prompt module, and prompt unit may be as follows.

Prompt layer 1 may be a prompt layer performing a main function related to disease extraction and topic identification, and may include a prompt module A that performs a detailed function of natural language processing and a prompt module B that performs a detailed function of disease classification.

Prompt module A may include a plurality of prompt units. For example, prompt module A may include: a prompt unit A1 that generates a command sentence of “Identify the intent of the question.”; a prompt unit A2 that generates a command sentence of “Extract the important keywords.”; and a prompt unit A3 that generates a command sentence of “Identify the information required to provide the answer.”

Prompt module B may include a plurality of prompt units. For example, prompt module B may include: a prompt unit B1 that generates a command sentence of “Accurately extract the medical procedure mentioned in the given question.”; a prompt unit B2 that generates a command sentence of “Identify the main diseases or symptoms associated with the extracted medical procedure.”; and a prompt unit B3 that generates a command sentence of “Output the identified disease or symptom in the format ‘Disease Name: [disease name]’.”

Prompt layer 1 may be composed of a plurality of prompt unit pools. For example, prompt layer 1 may include at least one prompt unit pool selected from among an intent identifier, keyword extractor, information requirement detector, medical procedure extractor, disease/symptom identifier, and disease name formatter.

Prompt layer 2 may be a prompt layer performing a main function related to information retrieval and context construction, and may include a prompt module A that performs a detailed function of AI-based search engine, a prompt module B that performs a detailed function of document chunking, and a prompt module C that performs a detailed function of Word file processing.

Prompt module A may include a plurality of prompt units. For example, prompt module A may include: a prompt unit A1 that generates a command sentence of “Select an appropriate search method among semantic search, vector search, and hybrid search.”; a prompt unit A2 that generates a command sentence of “Search for relevant documents using ‘[disease name]’ and ‘review’ as keywords.”; a prompt unit A3 that generates a command sentence of “List the titles of the top three documents from the search results.”; a prompt unit A4 that generates a command sentence of “Select the document most relevant to ‘[disease name]’ among the listed documents.”; and a prompt unit A5 that generates a command sentence of “Extract three bullet points summarizing the key information related to the review process from the selected document.”

Prompt module B may include a plurality of prompt units. For example, prompt module B may include: a prompt unit B1 that generates a command sentence of “Divide the document into sentences to perform fine-grained search.”; a prompt unit B2 that generates a command sentence of “Divide the document into paragraphs to maintain intermediate-level context.”; and a prompt unit B3 that generates a command sentence of “Divide the document into sections or pages to include broad context.”

Prompt module C may include a plurality of prompt units. For example, prompt module C may include: a prompt unit C1 that generates a command sentence of “Recognize the text with headers and footers removed.”; a prompt unit C2 that generates a command sentence of “If a table of contents exists, compare the important keywords with the table of contents and focus the search on the relevant sections.”; a prompt unit C3 that generates a command sentence of “If tables exist, recognize rows and columns to interpret the information.”; and a prompt unit C4 that generates a command sentence of “Analyze images using OCR and extract necessary information and text.”

Prompt module D may include a plurality of prompt units. For example, prompt module D may include: a prompt unit D1 that generates a command sentence of “Search for information by understanding the context of rows and columns.”; a prompt unit D2 that generates a command sentence of “Identify the type of information by tab and utilize the necessary parts.”; and a prompt unit D3 that generates a command sentence of “Specify the actual header range of the table and infer the meaning of each column.”

Prompt layer 2 may be composed of a plurality of prompt unit pools. For example, prompt layer 2 may include at least one prompt unit pool selected from among a search method selector, keyword-based retriever, document relevance evaluator, information extractor, sentence-level splitter, paragraph-level splitter, section-level splitter, Word file preprocessor, table-of-contents-based retriever, table information extractor, OCR processor, and Excel file structure analyzer.

Prompt layer 3 may be a prompt layer performing a main function related to response generation, and may include a prompt module A that performs a detailed function of text generation, a prompt module B that performs a detailed function of personal information processing, and a prompt module C that performs a detailed function of information integration.

Prompt module A may include a plurality of prompt units. For example, prompt module A may include: a prompt unit A1 that generates a command sentence of “Based on the extracted information, describe the first step of the review procedure when ‘[disease name]’ is found, in one sentence.”; a prompt unit A2 that generates a command sentence of “Describe the second step of the review procedure in one sentence.”; a prompt unit A3 that generates a command sentence of “Describe the third step of the review procedure in one sentence.”; a prompt unit A4 that generates a command sentence of “Add one sentence describing special precautions to be taken during the review process.”; a prompt unit A5 that generates a command sentence of “Add explanations for technical terms related to medicine, insurance, finance, or law if necessary.”; and a prompt unit A6 that generates a command sentence of “Refine the answer to make it clear, concise, and easy to understand.”

Prompt module B may include a plurality of prompt units. For example, prompt module B may include: a prompt unit B1 that generates a command sentence of “Identify personal information included in the response.”; a prompt unit B2 that generates a command sentence of “Identify personal information specific to particular fields beyond common categories.”; and a prompt unit B3 that generates a command sentence of “Mask the identified personal information.”

Prompt module C may include a plurality of prompt units. For example, prompt module C may include: a prompt unit C1 that generates a command sentence of “Summarize the key content of the selected documents into one integrated text.”; a prompt unit C2 that generates a command sentence of “Extract the main points from each document and organize them into a structured list.”; and a prompt unit C3 that generates a command sentence of “Identify conflicting information among documents and prepare a summary that explicitly contrasts them.”

Prompt layer 3 may be composed of a plurality of prompt unit pools. For example, prompt layer 3 may include at least one prompt unit pool selected from among a step-description generator, caution generator, technical-term explainer, answer optimizer, personal information identifier, personal information masker, document summarizer, information structurer, and information comparison analyzer.

Prompt layer 4 may be a prompt layer performing a main function related to quality verification and improvement, and may include a prompt module A that performs a detailed function of response evaluation.

Prompt module A may include a plurality of prompt units. For example, prompt module A may include: a prompt unit A1 that generates a command sentence of “Check whether the generated response mentions both ‘colonoscopy’ and ‘polyp,’ and answer ‘Yes’ or ‘No.’”; a prompt unit A2 that generates a command sentence of “Evaluate whether the response clearly explains the review procedure in distinct steps and rate it on a scale of 1 to 5.”; a prompt unit A3 that generates a command sentence of “Highlight the most important review criterion or procedure from the response in one sentence.”; and a prompt unit A4 that generates a command sentence of “Identify one aspect of the response that requires improvement and suggest a specific improvement plan in one sentence.”

Prompt layer 4 may be composed of a plurality of prompt unit pools. For example, prompt layer 4 may include at least one prompt unit pool selected from among a keyword inclusion checker, step description evaluator, key content highlighter, and improvement identifier.

The structures of initial pipelines 1 and 2 may be as follows.

The initial pipeline 1 may be a precision analysis structure and may include prompt layers 1 through 4.

Prompt layer 1 may include a prompt module A, and the prompt module A may include prompt units A1 through A3.

Prompt layer 2 may include a prompt module B, and the prompt module B may include prompt units B1 through B4.

Prompt layer 3 may include a prompt module C, and the prompt module C may include prompt units C1 through C4.

Prompt layer 4 may include a prompt module D, and the prompt module D may include prompt units D1 through D4.

The initial pipeline 2 may be a large-scale data processing structure and may include prompt layers 1 through 4.

Prompt layer 1 may include a prompt module E, and the prompt module E may include prompt units E1 through E3.

Prompt layer 2 may include a prompt module F, and the prompt module F may include prompt units F1 through F8.

Prompt layer 3 may include a prompt module G, and the prompt module G may include prompt units G1 through G5.

Prompt layer 4 may include a prompt module H, and the prompt module H may include prompt units H1 through H3.

When the pipeline construction apparatus fails to generate an optimal response to a question through the pipeline structure, the apparatus may perform a retry operation.

For example, when a specific prompt unit fails, a prompt unit-level replacement may be performed by replacing it with another prompt unit having the same purpose. For instance, when the prompt unit A1 of prompt layer 1 in pipeline 1 fails, the pipeline construction apparatus may replace it with another prompt unit included in a different prompt layer or a different prompt module.

In another example, when the performance of a specific prompt module is low, a prompt module-level replacement may be performed by replacing it with an equivalent prompt module from another pipeline. For instance, when the prompt module B of prompt layer 2 in pipeline 1 fails, the pipeline construction apparatus may replace it with the prompt module F of pipeline 2.

In yet another example, when a specific prompt layer fails as a whole, the layer may be reconfigured by combining new prompt modules. For instance, prompt layer 3 may be reconfigured as a combination of prompt module C and prompt module G.

In another example, a new pipeline may be constructed by combining the strengths of multiple pipelines. For instance, a hybrid pipeline may include prompt layers 1 through 4. Prompt layer 1 may include the prompt module E from pipeline 2, prompt layer 2 may include the prompt module B from pipeline 1, prompt layer 3 may include the prompt modules C from pipeline 1 and G from pipeline 2, and prompt layer 4 may include the prompt module D from pipeline 1.

When the pipeline construction apparatus fails to generate an optimal response through the pipeline structure, it may perform a dynamic reconfiguration and optimization process. Here, the optimization process may be a meta-level process that monitors and optimizes the overall performance of the pipeline.

For example, the pipeline construction apparatus may perform performance monitoring. Specifically, the apparatus may monitor in real time the overall performance of each pipeline and the performance of individual prompt layers, and may track indicators such as accuracy, processing speed, and resource usage.

In another example, the pipeline construction apparatus may initiate a reconfiguration process when a specific performance metric falls below a threshold, or based on at least one of user feedback or external factors. For instance, the pipeline construction apparatus may initiate a reconfiguration process when a new type of document is input.

In another example, the pipeline construction apparatus may explore an optimal pipeline configuration using a genetic algorithm or a reinforcement learning technique, and may learn from the results by attempting various combinations of prompt units and prompt modules.

In yet another example, the pipeline construction apparatus may execute a new pipeline configuration and an existing pipeline configuration in parallel to compare their performances, and may select and apply the pipeline with higher performance based on the comparison result.

In another example, the pipeline construction apparatus may gradually apply small-scale modifications to maintain system stability and may perform monitoring for a certain period after applying the changes to evaluate long-term effects.

In another example, the pipeline construction apparatus may store information regarding successful and failed pipeline structures in a database and may reflect such information in future reconfiguration processes.

Through this approach, the pipeline construction apparatus can flexibly respond to various document formats, data structures, and question types, and can exhibit increasingly effective performance over time through continuous learning and optimization.

The pipeline construction apparatus may execute multiple pipelines in parallel for the same question, thereby deriving an optimal answer through diverse processing paths.

The pipeline construction apparatus may selectively use various prompt modules and prompt units within each prompt layer, enabling the configuration of an optimized processing path according to the characteristics of the question.

The pipeline construction apparatus may evaluate the performance of each pipeline in real time and may either select the highest-performing pipeline or combine superior prompt modules across pipelines to optimize the final result.

The pipeline construction apparatus may consider different levels of context through document chunking strategies and may perform analyses of appropriate depth depending on the complexity of the question.

The pipeline construction apparatus may utilize a wide range of information sources through dedicated prompt modules capable of processing various document formats such as Word and Excel.

The pipeline construction apparatus may continuously learn and improve based on user feedback and automatic evaluation results, thereby providing more accurate and relevant responses over time.

By operating multiple pipelines simultaneously, the pipeline construction apparatus can enhance system stability, as the results of other pipelines can be utilized even when one pipeline fails.

The pipeline construction apparatus may individually evaluate the outputs of each pipeline and perform multi-faceted quality verification of the final response, thereby maintaining a high level of response quality.

The pipeline construction apparatus may easily add and test new prompt modules or prompt units, thereby continuously expanding and improving system functionality.

The pipeline construction apparatus may include prompt modules and prompt units specialized for specific domains, such as insurance review, thereby generating responses that accurately reflect expert knowledge and processes in the relevant field.

In another example, the pipeline construction apparatus may be applied to a dynamically reconfigurable RAG system for HR query handling.

For example, when the input question is “Please tell me about our company’s parental leave policy and return-to-work procedure,” examples of prompt layers, prompt modules, and prompt units may be as follows.

Prompt layer 1 may be a prompt layer performing a main function related to document selection and preprocessing, and may include a prompt module A that performs a detailed function of identifying relevant documents, and a prompt module B that performs a detailed function of document preprocessing.

Prompt module A may include a plurality of prompt units. For example, prompt module A may include a prompt unit A1 that performs keyword-based document filtering, a prompt unit A2 that performs document title similarity analysis, and a prompt unit A3 that performs semantic analysis of document summaries.

Prompt module B may include a plurality of prompt units. For example, prompt module B may include a prompt unit B1 that removes HTML tags, a prompt unit B2 that performs special character normalization, and a prompt unit B3 that performs paragraph structure recognition.

Prompt layer 2 may be a prompt layer performing a main function related to information extraction, and may include a prompt module C that performs a detailed function of text chunking and a prompt module D that performs a detailed function of extracting relevant information.

Prompt module C may include a plurality of prompt units. For example, prompt module C may include a prompt unit C1 that performs fixed-length chunking, a prompt unit C2 that performs sentence-based chunking, and a prompt unit C3 that performs semantic-unit chunking.

Prompt module D may include a plurality of prompt units. For example, prompt module D may include a prompt unit D1 that performs keyword-based related phrase extraction, a prompt unit D2 that performs semantic similarity-based sentence extraction, and a prompt unit D3 that performs question–answer pair extraction.

Prompt layer 3 may be a prompt layer performing a main function related to context construction, and may include a prompt module E that performs a detailed function of information integration and a prompt module F that performs a detailed function of context optimization.

Prompt module E may include a plurality of prompt units. For example, prompt module E may include a prompt unit E1 that performs chronological information ordering, a prompt unit E2 that performs topic-based information clustering, and a prompt unit E3 that performs importance-based information ranking.

Prompt module F may include a plurality of prompt units. For example, prompt module F may include a prompt unit F1 that performs duplicate information removal, a prompt unit F2 that performs contradiction resolution, and a prompt unit F3 that performs missing information supplementation.

Prompt layer 4 may be a prompt layer performing a main function related to response generation, and may include a prompt module G that performs a detailed function of draft answer generation and a prompt module H that performs a detailed function of answer refinement.

Prompt module G may include a plurality of prompt units. For example, prompt module G may include a prompt unit G1 that performs summary-based answer generation, a prompt unit G2 that performs template-based answer composition, and a prompt unit G3 that performs question decomposition followed by individual answer generation.

Prompt module H may include a plurality of prompt units. For example, prompt module H may include a prompt unit H1 that performs addition of technical term explanations, a prompt unit H2 that performs insertion of examples and case descriptions, and a prompt unit H3 that performs answer structuring (e.g., bullet points or step-by-step explanations).

The structures of the initial pipelines 1 through 3 may be as follows.

The initial pipeline 1 may include prompt layers 1 through 4.

Prompt layer 1 may include prompt units A1 and B2.

Prompt layer 2 may include prompt units C2 through D1.

Prompt layer 3 may include prompt units E2 through F1.

Prompt layer 4 may include prompt units G2 through H3.

The initial pipeline 2 may include prompt layers 1 through 4.

Prompt layer 1 may include prompt units A2 through B3.

Prompt layer 2 may include prompt units C3 through D2.

Prompt layer 3 may include prompt units E3 through F2.

Prompt layer 4 may include prompt units G1 through H2.

The initial pipeline 3 may include prompt layers 1 through 4.

Prompt layer 1 may include prompt units A3 through B1.

Prompt layer 2 may include prompt units C1 through D3.

Prompt layer 3 may include prompt units E1 through F3.

Prompt layer 4 may include prompt units G3 through H1.

When the pipeline construction apparatus fails to generate an optimal response to a question through a given pipeline structure, the apparatus may perform a dynamic reconfiguration and optimization process.

The pipeline construction apparatus may perform performance monitoring. For example, the apparatus may measure the processing time of each pipeline, calculate a quality score for each pipeline output, and evaluate the overall response quality of the entire pipeline system.

The pipeline construction apparatus may diagnose problems. For example, the apparatus may identify pipelines with performance degradation, classify the type of problem, and assess the severity of the issue. Here, the problem type may include at least one of speed, accuracy, and relevance.

The pipeline construction apparatus may perform pipeline optimization. For example, the apparatus may individually evaluate the performance of prompt units within a problematic prompt layer, select alternative prompt units from a prompt unit pool, and replace the underperforming prompt unit with an optimal one based on immediate testing and performance comparison of the selected prompt units.

The pipeline construction apparatus may construct a new pipeline. For example, the apparatus may analyze the efficiency of the current pipeline configuration, propose an alternative pipeline configuration, and perform a simulation test of the proposed configuration to replace the existing pipeline with the configuration exhibiting the best performance.

The pipeline construction apparatus may perform learning and improvement. For example, the apparatus may record patterns of successful pipeline configurations, update performance data of prompt units and pipelines, analyze the need for new prompt units, and generate system improvement items.

When the pipeline construction apparatus fails to generate an optimal response to a question through a given pipeline structure, it may perform a retry process.

For example, if a lack of information extraction regarding parental leave and return-to-work procedures is identified as a problem in the initial execution result of pipeline 1, the pipeline construction apparatus may perform pipeline optimization.

In this case, the pipeline construction apparatus may perform optimization by replacing D1 with D2 in prompt layer 2 of pipeline 1, and as a result, it may find that the amount of extracted information increases while accuracy decreases.

The pipeline construction apparatus may perform a new pipeline configuration based on the obtained result.

For example, the apparatus may construct a new pipeline based on the structure of pipeline 2 while replacing D2 in prompt layer 2 with D3, and may obtain a result indicating that information related to the parental leave policy has improved, while information related to the return-to-work procedure remains insufficient.

The pipeline construction apparatus may introduce an additional prompt layer based on the obtained result.

For example, the apparatus may add a new prompt layer for information expansion between prompt layer 2 and prompt layer 3 of all pipelines. The new prompt layer may include a new prompt module that performs a function of referencing related regulations, and may include prompt units configured to perform “searching external HR policy databases” and “referencing similar company cases,” respectively. As a result, the pipeline construction apparatus may obtain an outcome indicating successful supplementation of detailed information regarding the return-to-work procedure.

The pipeline construction apparatus may construct a final pipeline.

For example, the final pipeline may include prompt layers 1 through 5. Prompt layer 1 may include A2 and B3 retained from pipeline 2. Prompt layer 2 may include C3 and D3, with D2 being replaced by D3. Prompt layer 3 may be a newly added prompt layer. Prompt layer 4 may include E3 and F2 retained from prompt layer 3 of pipeline 2. Prompt layer 5 may include G2 and H3, with G1 being replaced by G2 and H2 being replaced by H3.

The pipeline construction apparatus may generate a comprehensive and detailed answer regarding parental leave policies and return-to-work procedures through the final pipeline.

As described above, the pipeline construction apparatus may construct multiple pipelines using various combinations of prompt units and may select an optimal pipeline according to the situation.

The pipeline construction apparatus may dynamically reconfigure a pipeline at the prompt unit level in response to performance issues.

The pipeline construction apparatus may easily expand system functionality by adding new prompt units or prompt layers.

Even if one pipeline fails, the pipeline construction apparatus may immediately apply an alternative pipeline, thereby improving system stability.

The pipeline construction apparatus may analyze successful and failed cases, thereby establishing a structure that allows the system to continuously evolve.

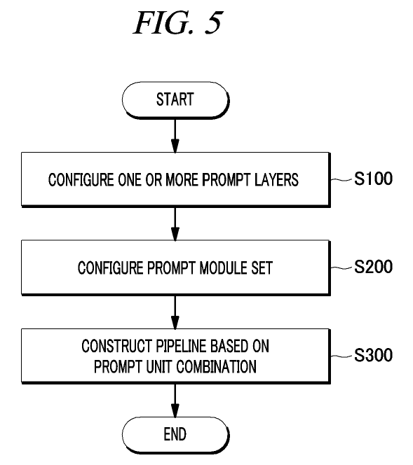

FIG. 5 is a flowchart illustrating the sequence of an automated response-providing method of a pipeline structure according to another embodiment of the present disclosure.

The pipeline construction method described below may be performed by the pipeline construction apparatus (100) or a server, as described with reference to FIGS. 1 to 4. Accordingly, the contents described in the embodiments of the present disclosure with reference to FIGS. 1 to 4 may also apply to the embodiments described below, and overlapping descriptions will be omitted for simplicity. The steps described below are not necessarily performed sequentially; the order of steps may be varied, and some steps may be performed substantially simultaneously.

Referring to FIG. 5, the pipeline construction method may include one or more prompt layer configuration steps (S100), a prompt module set configuration step (S200), and a pipeline construction step (S300) according to combinations of prompt units.

The one or more prompt layer configuration step (S100) may include configuring one or more prompt layers selected based on at least one of the availability, cost, and performance of candidate artificial intelligence models. Here, the prompt layer may perform a main function for providing an answer to a question input to the pipeline.

For example, the one or more prompt layer configuration step (S100) may include filtering a plurality of artificial intelligence models based on at least one of operational status, availability, and processing capacity, and extracting one or more artificial intelligence models from the filtered models based on at least one of budget, answer generation time for a question, processing speed, and score, to configure one or more prompt layers.

The prompt module set configuration step (S200) may include configuring a prompt module set for each layer according to the selected artificial intelligence model. Here, each of one or more prompt modules corresponding to each of the one or more artificial intelligence models may include a plurality of differently combined prompt units, and each prompt module may be preset according to the artificial intelligence model to perform a detailed function for accomplishing a main function.

The pipeline construction step (S300) according to the combination of prompt units may include selecting, from among preset candidate prompt units for each of the prompt modules included in the prompt module set, one or more prompt units satisfying specific conditions, and constructing a pipeline by configuring combinations of prompt units for each of the prompt modules included in the prompt module set based on the selected prompt units. Here, each prompt unit may be a command for executing a detailed function.

For example, the pipeline construction step (S300) according to the combination of prompt units may include extracting prompt units from among the preset candidate prompt units based on at least one of an error state, user feedback score, internal confidence level, and question.

The pipeline construction step (S300) according to the combination of prompt units may further include, when it is determined that the configuration of a prompt unit combination has failed according to a preset prompt unit selection criterion, replacing one or more prompt units that do not satisfy the preset prompt unit selection criterion with other prompt units having the same purpose; when it is determined that the configuration of a prompt module set has failed according to a preset prompt module configuration criterion, replacing one or more prompt modules that do not satisfy the preset prompt module configuration criterion with other prompt modules having the same purpose; and when it is determined that the configuration of a prompt layer has failed according to a preset prompt layer configuration criterion, changing the configuration of the prompt module set.

For example, when the prompt layer includes a first prompt layer and a second prompt layer that are sequentially interconnected such that the output of the first prompt layer is provided as the input of the second prompt layer, and the output of the first prompt layer does not satisfy preset input requirements of the second prompt layer, the method may include changing the configuration of the prompt module and prompt unit for at least one of the first prompt layer and the second prompt layer.

The pipeline construction step (S300) according to the combination of prompt units may further include monitoring the performance of the pipeline configured with one or more prompt layers and optimizing the pipeline based on the monitored performance.

For example, the step of optimizing the pipeline may include monitoring, in real time, at least one of overall performance of the pipeline and performance of each of one or more prompt layers.

The step of optimizing the pipeline may include changing the configuration of the pipeline when a performance index of the pipeline is equal to or lower than a preset performance threshold.

The step of optimizing the pipeline may include exploring an optimal configuration of the pipeline based on at least one of a genetic algorithm and a reinforcement learning technique to derive an answer to a question through the pipeline, and storing and learning by matching the question, the answer, and the optimal configuration of the pipeline.

The step of optimizing the pipeline may include executing, in parallel, the configuration of the pipeline and configurations of one or more new pipelines different from the pipeline, and comparing the performance between the pipeline and the new pipelines.

The step of optimizing the pipeline may include storing information on successful configurations and failed configurations of the pipeline.

It will be understood by those skilled in the art that various modifications and changes can be made to the present disclosure without departing from the spirit or essential characteristics thereof, based on the above description. Therefore, the embodiments described above are illustrative in all respects and should not be construed as limiting. The scope of the present disclosure is defined by the appended claims, and all variations or modifications derived from the meaning, scope, and equivalents of the claims should be interpreted as being included within the scope of the present disclosure.

### MODE FOR CARRYING OUT THE INVENTION

The mode for carrying out the invention is substantially the same as the best mode for carrying out the invention described above.

### INDUSTRIAL APPLICABILITY

The present invention is applicable to question-and-answer providing services utilizing artificial intelligence, and therefore has industrial applicability.

What is claimed is:

1. A pipeline construction method based on combinations of prompt units, the method being performed by at least one processor, comprising:
a) configuring one or more prompt layers selected from among candidate artificial intelligence models based on at least one of availability, cost, and performance of each artificial intelligence model;
b) configuring a set of prompt modules for each of the prompt layers according to the artificial intelligence model selected in step (a); and
c) constructing a pipeline by: selecting, from among preset candidate prompt units for each of the prompt modules included in the prompt module set, one or more prompt units satisfying specific conditions; and configuring, based on the selected prompt units, a combination of prompt units for each of the prompt modules included in the prompt module set,
whereby the pipeline is constructed based on combinations of prompt units.

2. The pipeline construction method based on combinations of prompt units according to claim 1,
wherein each of the prompt layers sequentially performs a main function of providing an answer to a question input to the pipeline,
each of the prompt modules performs a detailed function for accomplishing the main function performed by a corresponding prompt layer in which it is included, and
each of the prompt units is a command for executing the detailed function performed by a corresponding prompt module in which it is included.

3. The pipeline construction method based on combinations of prompt units according to claim 1,
wherein step (c) comprises:
c-1) when it is determined that configuration of a prompt unit combination has failed according to a preset prompt unit selection criterion, replacing, from among the prompt units included in the prompt unit combination, a prompt unit that does not satisfy the preset prompt unit selection criterion with another prompt unit having the same purpose;
when it is determined that configuration of a prompt module set has failed according to a preset prompt module configuration criterion, replacing, from among the prompt modules included in the prompt module set, a prompt module that does not satisfy the preset prompt module configuration criterion with another prompt module having the same purpose; and
when it is determined that configuration of a prompt layer has failed according to a preset prompt layer configuration criterion, changing the configuration of the prompt module set.

4. The pipeline construction method based on combinations of prompt units according to claim 3,
wherein the pipeline comprises a first prompt layer and a second prompt layer sequentially interconnected with each other, and
step (c-1) comprises, when an output of the first prompt layer is used as an input of the second prompt layer and the output of the first prompt layer does not satisfy preset input requirements of the second prompt layer, changing the configuration of the prompt module and the prompt unit for at least one of the first prompt layer and the second prompt layer.

5. The pipeline construction method based on combinations of prompt units according to claim 1,
further comprising:
d) monitoring and optimizing performance of the pipeline configured to include one or more prompt layers.

6. The pipeline construction method based on combinations of prompt units according to claim 5,
wherein step (d) comprises monitoring, in real time, at least one of overall performance of the pipeline and performance of each of one or more prompt layers.

7. The pipeline construction method based on combinations of prompt units according to claim 5,
wherein step (d) comprises changing a configuration of the pipeline when a performance index of the pipeline is equal to or lower than a preset performance threshold.

8. The pipeline construction method based on combinations of prompt units according to claim 5,
wherein step (d) comprises exploring an optimal configuration of the pipeline based on at least one of a genetic algorithm and a reinforcement learning technique to derive an answer to a question using the pipeline, and storing and learning by matching the question, the answer, and the optimal configuration of the pipeline.

9. The pipeline construction method based on combinations of prompt units according to claim 5,
wherein step (d) comprises executing, in parallel, configurations of the pipeline and one or more new pipelines different from the pipeline, and comparing performance between the pipeline and the new pipelines.

10. The pipeline construction method based on combinations of prompt units according to claim 5,
wherein step (d) comprises storing information respectively corresponding to a successful configuration and a failed configuration of the pipeline.

11. The pipeline construction method based on combinations of prompt units according to claim 1,
wherein step (a) comprises:
a-1) filtering a plurality of artificial intelligence models based on at least one of operability, availability, and processing capacity; and
a-2) extracting, from among the filtered artificial intelligence models, one or more artificial intelligence models based on at least one of cost, answer generation time for a question, processing speed, and score, and configuring one or more prompt layers based on the extracted artificial intelligence models.

12. The pipeline construction method based on combinations of prompt units according to claim 1,
wherein step (c) comprises extracting a prompt unit from among preset candidate prompt units based on at least one of error occurrence, user feedback score, self-confidence level, and the question.

13. A pipeline construction apparatus based on combinations of prompt units, comprising:
a communication module;
at least one processor; and
a memory electrically connected to the processor and storing at least one code executable by the processor,
wherein the memory, when executed by the processor, causes the processor to:
configure one or more prompt layers selected from among candidate artificial intelligence models based on at least one of availability, cost, and performance of each artificial intelligence model;
configure, for each layer, a set of prompt modules according to the selected artificial intelligence model;
select, from among preset candidate prompt units for each of the prompt modules included in the prompt module set, one or more prompt units satisfying specific conditions; and
construct a pipeline by configuring, based on the selected prompt units, a combination of prompt units for each of the prompt modules included in the prompt module set.

14. The pipeline construction apparatus based on combinations of prompt units according to claim 13,
wherein each of the prompt layers sequentially performs a main function of providing an answer to a question input to the pipeline,
each of the prompt modules performs a detailed function for accomplishing the main function performed by a corresponding prompt layer in which it is included, and
each of the prompt units is a command for executing the detailed function performed by a corresponding prompt module in which it is included.

15. The pipeline construction apparatus based on combinations of prompt units according to claim 13,
wherein the memory stores code that, when executed by the processor, causes the processor to:
when it is determined that configuration of a prompt unit combination has failed according to a preset prompt unit selection criterion, replace, from among the prompt units included in the prompt unit combination, a prompt unit that does not satisfy the preset prompt unit selection criterion with another prompt unit having the same purpose;
when it is determined that configuration of a prompt module set has failed according to a preset prompt module configuration criterion, replace, from among the prompt modules included in the prompt module set, a prompt module that does not satisfy the preset prompt module configuration criterion with another prompt module having the same purpose; and when it is determined that configuration of a prompt layer has failed according to a preset prompt layer configuration criterion, change the configuration of the prompt module set.

16. The pipeline construction apparatus based on combinations of prompt units according to claim 15,
wherein the pipeline comprises a first prompt layer and a second prompt layer sequentially interconnected with each other, and
the memory stores code that, when executed by the processor, causes the processor to change configurations of the prompt module and the prompt unit for at least one of the first prompt layer and the second prompt layer when an output of the first prompt layer is used as an input of the second prompt layer and the output of the first prompt layer does not satisfy preset input requirements of the second prompt layer.

17. The pipeline construction apparatus based on combinations of prompt units according to claim 13,
wherein the memory stores code that, when executed by the processor, causes the processor to monitor and optimize performance of the pipeline configured to include one or more prompt layers.

18. The pipeline construction apparatus based on combinations of prompt units according to claim 13,
wherein the memory stores code that, when executed by the processor, causes the processor to filter a plurality of artificial intelligence models based on at least one of operability, availability, and processing capacity, and to extract, from among the filtered artificial intelligence models, one or more artificial intelligence models based on at least one of cost, answer generation time for a question, processing speed, and score, and to configure one or more prompt layers based on the extracted artificial intelligence models.

19. The pipeline construction apparatus based on combinations of prompt units according to claim 13,
wherein the memory stores code that, when executed by the processor, causes the processor to extract a prompt unit from among preset candidate prompt units based on at least one of error occurrence, user feedback score, self-confidence level, and the question.
